(19) United States
(12) Patent Application Publication
(10) Pub. No.: US 2025/0272536 A1
(43) Pub. Date: Aug. 28, 2025

(54) LEARNING APPARATUS, ESTIMATION APPARATUS, METHODS AND PROGRAMS FOR THE SAME

(71) Applicant: NIPPON TELEGRAPH AND TELEPHONE CORPORATION, Tokyo (JP)

(72) Inventor: Kentaro ONO, Tokyo (JP)

(73) Assignee: NIPPON TELEGRAPH AND TELEPHONE CORPORATION, Tokyo (JP)

(21) Appl. No.: 18/858,207

(22) PCT Filed: Apr. 20, 2022
(86) PCT No.: PCT/JP2022/018311

§ 371 Date: Oct. 18, 2024

(51) Int. Cl. G06N 3/0442; G06N 3/048

(52) U.S. Cl. CPC G06N 3/0442; G06N 3/048

(57) ABSTRACT

Provided is a learning device or the like that learns a gated RNN so as to perform information processing utilizing correlation between pieces of data at distant times in long sequence data without increasing a memory amount and time required for calculation processing so much as in the conventional technology. The learning device includes a gate calculation unit that obtains a gate z_{t,S} at a time point t using data x_{t,n,S} at the time point t included in sequence data for learning and a state vector h_{t-1,S} at the time point t, and the gate calculation unit uses an activation function γ that converges to 0 or 1 in a double exponential manner with respect to the input when obtaining the gate z_{t,S}.

### TECHNICAL FIELD

The present invention relates to a learning device that learns a gated recurrent neural network (hereinafter, also referred to as “RNN”) used in sequence data analysis, an estimation device that performs estimation using the learned gated recurrent neural network, methods of the devices, and a program.

### BACKGROUND ART

Sequence data analysis is a basic technology applied in many technical fields such as time series prediction, voice recognition, and natural language processing. In particular, sequence data analysis using an RNN, which is one of machine learning models, is an important technology because inference can be accurately performed even on high-dimensional complicated series data without a complicated data preprocessing procedure.

Among RNNs, a gated RNN incorporating a calculation structure called a gate mechanism is widely used in practical applications. Specific examples of the gated RNN include a Long Short Term Memory (hereinafter, also referred to as “LSTM”, see Non Patent Literature 1 and the like) and a Gated recurrent unit (hereinafter, also referred to as “GRU”, see Non Patent Literature 2 and the like).

A calculation structure of the gate mechanism will be described. First, the RNN generally has a structure in which a state vector representing the feature amount of the sequence data is provided therein, and a new state vector is calculated and updated from the input data of one time point and the state vector at that time. In the gated RNN, this update expression is defined by a component-wise convex combination of a state vector at that time and another vector (hereinafter, also referred to as an update term) obtained by appropriate calculation using input data at that time. A coefficient vector having a value between 0 and 1 in the convex combination is referred to as a gate. When a state vector at a certain time point t is hₜ₋₁, another vector obtained by appropriate calculation using input data xₜ at the time point t is ⁻h, and a gate is z, an update expression of the state vector is expressed as follows.

$$[ Math . 1 ]$$

$${h}_{t} = ( 1 - z ) ⊙ {h}_{t - 1} + z ⊙ \overline{h} \qquad ( 1 )$$

$$⊙ represents a product for each element of a vector . \qquad [ Math . 2 ]$$

When the gate z takes a value close to 0, the state vector hardly changes due to the state update, and when the gate z takes a value close to 1, the state vector is replaced with a different vector ⁻h. Since the gate is calculated according to the state vector at each time point and the input data, such a calculation structure allows the gated RNN to learn to dynamically hold or replace information. In other words, a gated RNN can dynamically learn an appropriate rate of change of a state vector. This is important for the RNN to learn the long-term dependency of the sequence data. That is, in order to utilize information of data at a certain time point for processing of data at a time point later than the certain time, the gate takes a value close to 0 at a time point therebetween, and the corresponding portion of the state vector is prevented from greatly changing, and thereby, the RNN can learn long-term dependency.

### CITATION LIST

### Non Patent Literature

Non Patent Literature 1: S. Hochreiter, J. Shcmidhuber, “Long Short-Term Memory”, Neural Computation, 9(8), 1735-1780, 1997.
Non Patent Literature 2: K. Cho, et al. “Learning Representations using RNN Encoder-decoder for Statistical Machine Translation”, arXiv preprint arXiv:1406.1078, 2014.

### SUMMARY OF INVENTION

### Technical Problem

However, there is a problem that it is difficult to learn to take a value very close to 0 or 1 for the gate of the RNN. This is due to the following factors.

The learning of the RNN is performed by a gradient method-based method. That is, regarding the parameter of the RNN, the gradient of the preset error function is calculated, and the update of the parameter based on the gradient is repeated. In this learning, as the value of the gate approaches 0 or 1, the gradient regarding the parameter inside the gate approaches 0. Therefore, the parameter cannot be sufficiently updated so that the gate further approaches 0 or 1. Due to this problem, the gated RNN cannot hold the information on the input data for several thousands or more times, and there is a problem that the accuracy is lowered in processing of data having a correlation with data at a distant time.

An existing technology of learning so that the gate can take a value close to 0 or 1 includes a method of adding an independent gate function so that the value of the gate approaches 0 or 1 (see Reference Literature 1).
(Reference Literature 1) A. Gu, et al. “Improving the Gating Mechanism of Recurrent Neural Networks”, ICML pp. 3800-3809, 2020.

However, this conventional technology has the disadvantage of increasing the number of parameters and operations required for gate calculation and increasing the amount of memory and time required for calculation processing.

An object of the present invention is to provide a learning device that learns a gated RNN so as to perform information processing utilizing a correlation between pieces of data at distant times in long sequence data without increasing a memory amount and time required for calculation processing as in the conventional technology, an estimation device using the learned gated RNN, methods of the devices, and a program.

### Solution to Problem

In order to solve the above problem, according to an aspect of the present invention, a learning device learns a gated recurrent neural network. The learning device includes a gate calculation unit that obtains a gate z_{t,S} at a time point t using data x_{t,n,S} at the time point t included in sequence data for learning and a state vector h_{t-1,S} at the time point t, and the gate calculation unit uses an activation function γ that converges to 0 or 1 in a double exponential manner with respect to the input when obtaining the gate z_{t,S}.

### Advantageous Effects of Invention

According to the present invention, it is possible to perform information processing utilizing correlation between pieces of data at distant times in long sequence data without increasing a memory amount and time required for calculation processing as in the conventional technology.

### BRIEF DESCRIPTION OF DRAWINGS

FIG. 1 is a diagram illustrating an effect of a first embodiment.

FIG. 2 is a diagram illustrating an effect of the first embodiment.

FIG. 3 illustrates a configuration example of an estimation system according to the first embodiment.

FIG. 4 is a functional block diagram of a learning device according to the first embodiment.

FIG. 5 is a diagram illustrating an example of a processing flow of the learning device according to the first embodiment.

FIG. 6 is a functional block diagram of an estimation device according to the first embodiment.

FIG. 7 is a diagram illustrating an example of a processing flow of the estimation device according to the first embodiment.

FIG. 8 is a diagram illustrating a learning time of a learning device according to a conventional technology and the learning device according to the first embodiment.

FIG. 9 illustrates a configuration example of a computer to which the present method is applied.

### DESCRIPTION OF EMBODIMENTS

Hereinafter, an embodiment of the present invention will be described. Note that, in the drawings to be used in the description below, components having the same functions or steps for performing the same processing will be denoted by the same reference numerals, and redundant description will be omitted. In the following description, the symbol “⁻” or the like used in the text would normally be notated immediately above the immediately following character, but is notated immediately before the character due to limitations of text notation. In an expression, such a symbol is notated at the original position. A process performed in units of elements of a vector or a matrix is applied to all elements of the vector or the matrix unless otherwise mentioned.

### Feature of First Embodiment

In the present embodiment, an auxiliary function is applied as a preceding stage of application of an activation function used for calculating the gate, and a calculation structure of the gate mechanism is modified so that the gate takes a value close to 0 or 1. The gated RNN is learned on the basis of the modified calculation structure, and the similar calculation structure of the gate mechanism is used at the time of estimation.

By learning so that the gate of the gated RNN outputs a value very close to 0 or 1, it is possible to perform highly accurate inference in sequence data having a correlation with an input at a distant time using the learned gated RNN.

In the present embodiment, even when the gate takes a value close to 0 or 1 at the time of parameter update at the time of learning, it is possible to prevent the gradient regarding the parameter related to the gate from extremely approaching 0. With this configuration, it is possible to learn to reduce the temporal change of the state vector of the gated RNN, and it is possible to appropriately process the correlation of the inputs and accurately perform inference.

Before describing the present embodiment, first, a gate calculation structure in a gated RNN such as LSTM and GRU will be described.

### <Gated RNN>

For simplicity, the gate in the GRU will be described. When t is an index representing time, x is input data at time t, R is a set of entire real numbers, a state vector of GRU at the time t is hₜ∈Rⁿ, and a state update expression is hₜ=F_{GRU} (hₜ₋₁, xₜ), the following expressions are satisfied.

$$[ Math . 3 ]$$

$${F}_{GRU} ( h , x ) = ( 1 - z ) ⊙ h + z ⊙ \overline{h} \qquad ( 1 )$$

$$[ Math . 4 ]$$

$$\overline{h} = tan h ( {U}_{h} ( h ⊙ σ ( {U}_{r} h + {W}_{r} x + {b}_{r} ) ) + {W}_{h} x + {b}_{h} ) ∈ {ℝ}^{n} \qquad ( 2 )$$

$$[ Math . 5 ]$$

$$z = σ ( {U}_{z} h + {W}_{z} x + {b}_{z} ) ∈ {( 0 , 1 )}^{n} \qquad ( 3 )$$

Here, tanh( ) is a hyperbolic tangent function, ⁻h is a vector representing information to be newly included in the state vector, and z is a gate called an update gate. However, the expressions as below are applied for each element.

$$[ Math . 6 ]$$

$$Sigmoid function σ ( x ) = \frac{1}{1 + {e}^{- x}} \qquad ( 4 )$$

$$[ Math . 7 ]$$

$$Hyperbolic tangent function tan h ( x ) = \frac{{e}^{x} - {e}^{- x}}{{e}^{x} + {e}^{- x}} \qquad ( 5 )$$

The sigmoid function and the hyperbolic tangent function are called activation functions. U_{z}, Uᵣ, Uₕ∈R^{n×n}, W_{z}, Wᵣ, Wₕ∈R^{n×d}, B_{z}, Bᵣ, Bₕ∈Rⁿ are parameters learned by learning of the gated RNN. Each component of the state vector h is multiplied by (1−z) in the item as below in the state update expression F_{GRU} (Expression (1)).

$$( 1 - z ) ⊙ h \qquad [ Math . 8 ]$$

When the value of the component of z is close to 1, the corresponding component of the state vector h is replaced with the corresponding component of the vector ⁻h representing the new information. On the other hand, when the value of the component of z is close to 0, the corresponding component of the state vector h is held without being changed. In other words, the closer the component of the gate z is to 1, the larger the change rate of the corresponding component of the state vector h becomes, and the closer the component of the gate z is to 0, the smaller the change rate of the corresponding component of the state vector h becomes. With this calculation structure, GRU performs advanced information processing utilizing correlation between pieces of data at distant times.

The learning of GRUs, or more generally RNNs, takes place in the following procedure. First, a learning data set including a set of sequence data and a desired output value to be an input and a loss function L corresponding thereto are prepared. The gradient of the loss function L related to each parameter of the GRU is calculated for the output calculated by linear transformation or the like and the loss function L related to the desired output value from the state vector hₜ obtained by processing the input of the learning data by the GRU. The obtained gradient value is used to update the parameter by an optimization method such as a gradient method. Learning is performed by repeating the above.

Here, the gradient of the loss function L with respect to the parameter regarding the update gate, for example, the parameter b_{z}, is calculated as follows.

$$[ Math . 9 ]$$

$$\frac{\partial L}{\partial {b}_{z}} = {\sum }_{t} \frac{\partial {z}_{t}}{\partial {b}_{z}} \frac{\partial L}{\partial {z}_{t}} = {\sum }_{t} {z}_{t} ⊙ ( 1 - {z}_{t} ) ⊙ \frac{\partial L}{\partial {z}_{t}} \qquad ( 6 )$$

As the component of zₜ takes a value closer to 0 or 1, the corresponding component of the gradient approaches 0. As the corresponding component of the gradient approaches 0, the parameter changes little in the parameter update, making it difficult to learn the parameter to take a value that is closer to 0 or 1. As a result, it is difficult to perform learning so that the gate takes a value extremely close to 0 or 1, and it becomes difficult for the learned RNN to perform information processing in which a correlation with an input data at a distant time is captured.

### <Gated RNN of Present Embodiment>

Next, the present embodiment will be described. The learned gated RNN can learn so that the gate takes a value very close to 0 or 1 and perform accurate inference in sequence data having a correlation with data at a distant time.

In the gated RNN of the present embodiment, the activation function used for calculating the gate is replaced with a function that takes a large gradient even when the gate takes a value of 0 or close to 1. As a result, a gated RNN in which it is easier to perform learning such that the gate takes a value close to 0 or 1 is achieved.

The reason why it is difficult to learn such that the gate takes a value sufficiently close to 0 or 1 is that the closer the value of the gate is to 0 or 1, the more the gradient related to the parameter related to the gate approaches 0.

$$\frac{\partial L}{\partial {b}_{z}} , \frac{\partial L}{\partial {U}_{z}} , \frac{\partial L}{\partial {W}_{z}} \qquad [ Math . 10 ]$$

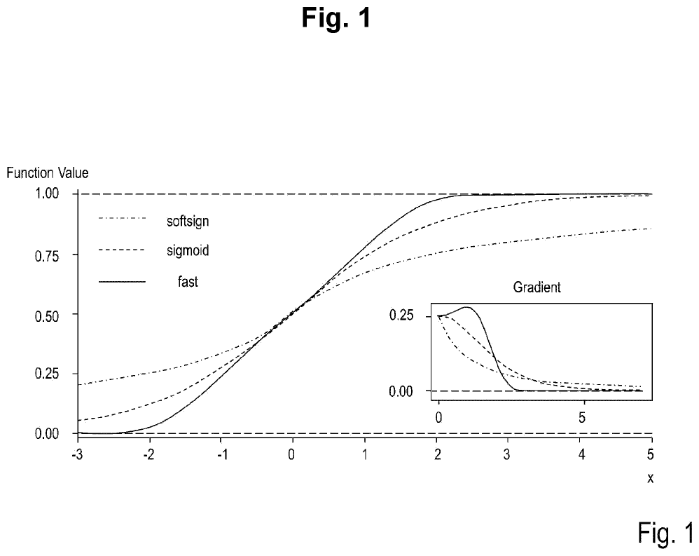

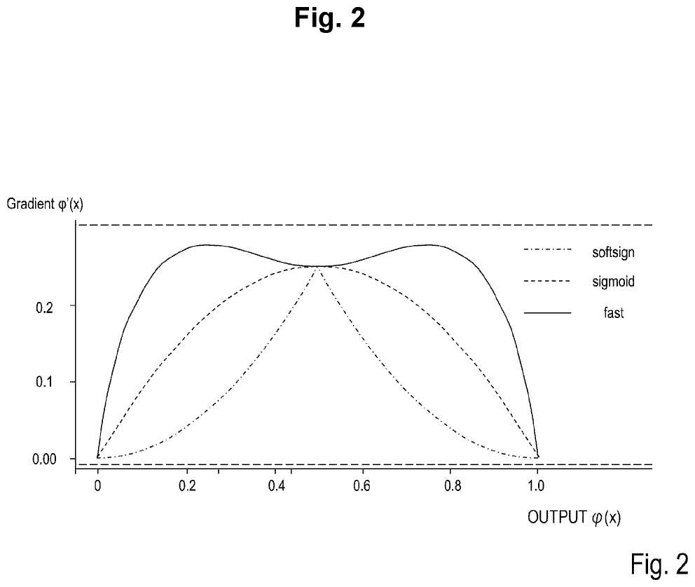

More precisely, the derivative σ′(x)=σ(x) (1−σ(x)) holds for the sigmoid function σ, which is an activation function used for the gate. Therefore, the gradient for the parameter is proportional to g_{σ}(z):=σ′(σ⁻¹(z))=z(1−z). When the value of the gate z approaches 0 or 1, g_{σ}(z) also approaches 0 at a speed of approximately z or 1−z. A point of the present embodiment is that g_{φ}(z):=φ′(φ⁻¹(z)) takes a value larger than g_{σ}(z) when the gate z approaches 0 or 1 by replacing the activation function of the gate from σ(x) with another function φ(x). By achieving this, the gradient for the parameters related to the gate becomes a larger value, and learning can be performed such that the gate takes a value closer to 0 or 1. In order to actually configure the function φ(x) satisfying the above, it is only required that the function φ(x) converges to 0 or 1 in an order faster than exponential in the limit in which x is increased positively or negatively. Such a function can be achieved by setting φ(x)=σ(α(x)) using an auxiliary function α(x) having a large increase rate. For example, when the hyperbolic sine function sin h(x) is used as the function α(x) to define φ(x)=σ(sin h(x)), the function φ(x) converges to 0 or 1 doubly exponentially with respect to x. FIGS. 1 and 2 illustrate an effect of the present embodiment. In the drawing, “softsign” relates to a soft sine function, “sigmoid” relates to a sigmoid function σ, and “fast” relates to a function φ(x)=σ(sin h(x)) to which the idea of the present embodiment is applied. It can be seen from FIG. 1 that the function φ(x) converges to 1 faster than the soft sine function and the sigmoid function as the input x increases. It is understood from FIG. 2 that the derivative φ′(x) of the function φ(x) takes a value larger than the derivative of each of the soft sine function and the sigmoid function when the function φ(x) is close to 1. This increases the gradient for parameters related to the gate and allows the gate to learn to take values close to 0 or 1. Furthermore, unlike the existing method, this method does not introduce a new learning parameter, and thus can be achieved so as to hardly increase the calculation time.

### <Estimation System According to First Embodiment>

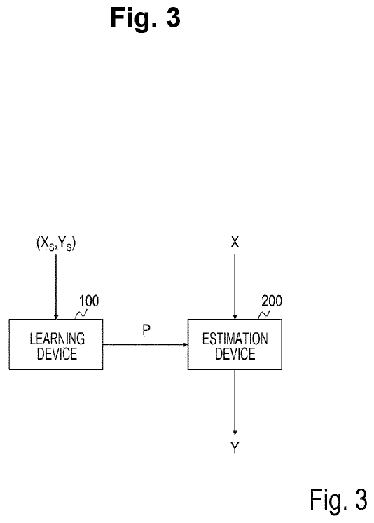

FIG. 3 illustrates a configuration example of an estimation system according to the present embodiment. The estimation system of the present embodiment includes a learning device 100 and an estimation device 200.

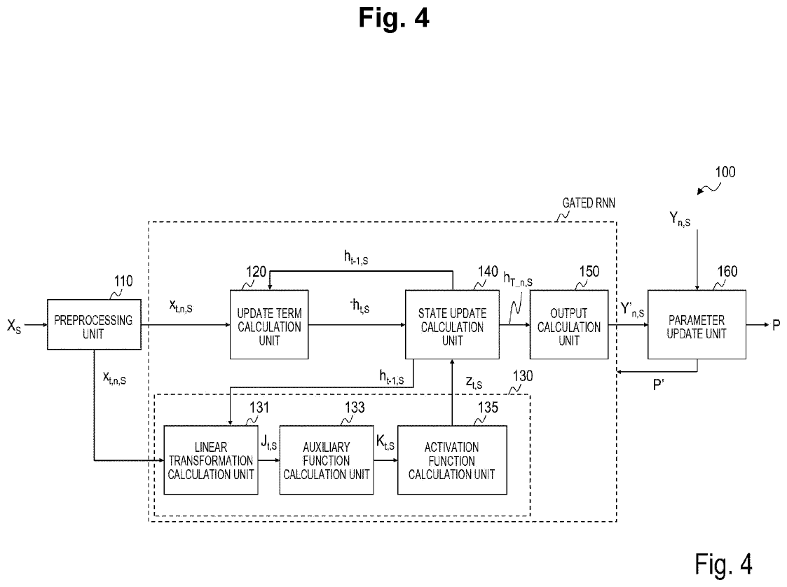

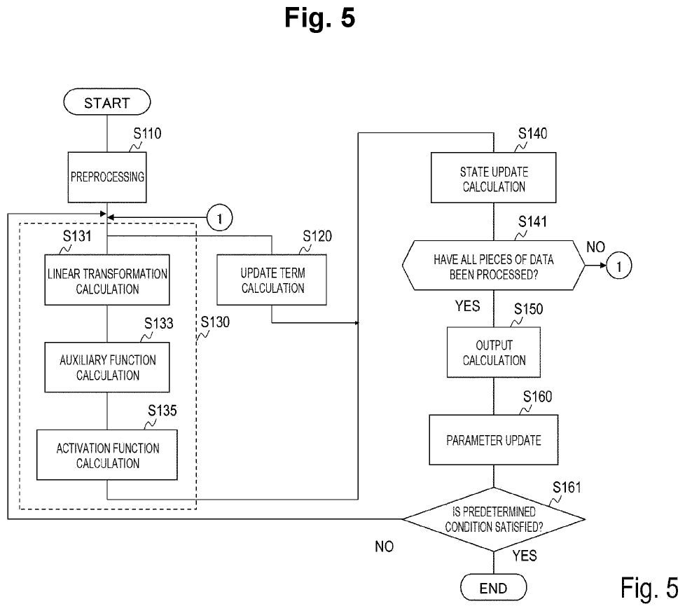

FIG. 4 is a functional block diagram of the learning device 100 according to the first embodiment, and FIG. 5 illustrates a processing flow thereof.

The learning device 100 includes a preprocessing unit 110, an update term calculation unit 120, a gate calculation unit 130, a state update calculation unit 140, an output calculation unit 150, and a parameter update unit 160.

The learning device 100 uses a learning data set (X_{S}, Y_{S}) including a set of N pieces of sequence data X_{S}=(X_{1,S}, X_{2,S}, . . . , X_{N,S}) and corresponding N desirable output values Y_{S}=(Y_{1,S}, Y_{2,S}, . . . , Y_{N,S}) as inputs, learns the gated RNN, and outputs a parameter P of the learned gated RNN. Here, N is the total number of sequence data included in the learning data set, n=1, 2, . . . , and N, and Y_{n,S} is a desirable output values for the n-th sequence data X_{n,S}. In addition, the subscript S is a symbol indicating that the data is for learning.

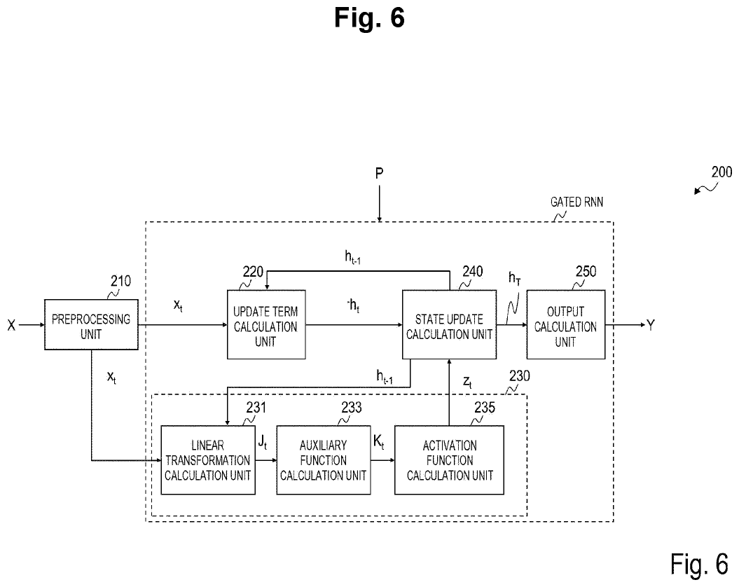

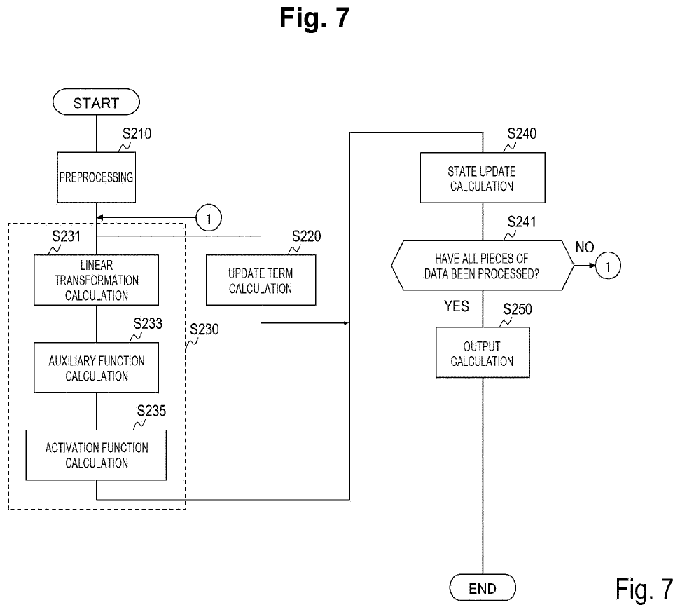

FIG. 6 is a functional block diagram of the estimation device 200 according to the first embodiment, and FIG. 7 shows a processing flow thereof.

The estimation device 200 includes a preprocessing unit 210, an update term calculation unit 220, a gate calculation unit 230, a state update calculation unit 240, and an output calculation unit 250.

The estimation device 200 receives learned parameters P of the gated RNN before an estimation process. The estimation device 200 receives the estimation target sequence data X as an input, performs the estimation process on the sequence data X, and outputs an estimation result Y.

The learning device 100 and the estimation device 200 are special devices configured by loading a special program into a known or dedicated computer including, for example, a central processing unit (CPU) and a main memory (random access memory (RAM)). The learning device 100 and the estimation device 200 perform each kind of processing under the control of the central processing unit, for example. Data input to the learning device 100 and the estimation device 200 and data obtained in each process are stored in the main memory, for example. The data stored in the main memory is read into the central processing unit and is used for other processes as necessary. At least one of the processing units in the learning device 100 and the estimation device 200 may be configured by hardware such as an integrated circuit. Each storage unit included in the learning device 100 and the estimation device 200 can be configured by, for example, the main memory such as a random access memory (RAM) or middleware such as a relational database or a key-value store. However, each storage unit is not necessarily included in the learning device 100 or the estimation device 200. Each storage unit may be configured by an auxiliary memory including a semiconductor memory element such as a hard disk, an optical disk, or a flash memory and be provided outside the learning device 100 and the estimation device 200.

### <Learning Device 100>

First, units of the learning device 100 will be described.

### <Preprocessing Unit 110>

The preprocessing unit 110 receives N pieces of sequence data X_{S}=(X_{1,S}, X_{2,S}, . . . , X_{N,S}) as inputs, converts the data into a form such as a vector that can be processed by the gated RNN (S110), and outputs the converted sequence data X′_{S}=(X′_{1,S}, X′_{2,S}, . . . , X′_{N,S}). X′_{n,S}=(x_{1,n,S}, x_{2,n,S}, . . . , x_{T_n,n,S}), t=1, 2, . . . , T_n, T_n is the total number of data included in the n-th sequence data X′_{n,S}, and x_{t,n,S} is the t-th data included in the n-th sequence data. Pieces of output data x_{t,n,S} at each time point are sequentially input to the gated RNN. The update term calculation unit 120, the gate calculation unit 130, the state update calculation unit 140, and the output calculation unit 150 correspond to the gated RNN.

The gated RNN independently performs two types of processing on the state vector hₜ₋₁ and the input data x_{t,n,S} at each time point t. One is calculation processing for extracting information of the data x_{t,n,S}, and is referred to as operation of an update term. The other is calculation processing of the gate z. In general, in this calculation, the activation function σ is applied after linear transformation, but in the present embodiment, an auxiliary function is applied during this time. A detailed description will be given in <Gate Calculation Unit 130> described later.

### <Update Term Calculation Unit 120>

The update term calculation unit 120 uses the data x_{t,n,S} at each time point t and the state vector h_{t-1,S} as inputs, calculates the update term ⁻h_{t,S} by the following expression using the parameters Uᵣ, Uₕ∈R^{n×n}, Wᵣ, Wₕ∈R^{n×d}, Bᵣ, Bₕ∈Rⁿ (S120), and outputs the update term ⁻h_{t,S}.

$$[ Math . 11 ]$$

$$\overline{h} = tan h ( {U}_{h} ( h ⊙ σ ( {U}_{r} h + {W}_{r} x + {b}_{r} ) ) + {W}_{h} x + {b}_{h} ) \qquad ( 11 )$$

In order to simplify the description, in the expression, the data x_{t,n,S} is denoted as data x, the state vector h_{t-1,S} is denoted as h, and ⁻h_{t,S} is denoted as ⁻h. Here, the data x_{t,n,S} is a d-dimensional vector, x_{t,n,S}=(x_{t,n,S} (1), x_{t,n,S}(2), . . . , x_{t,n,S}(d))^{T}, the state vector h_{t-1,S} is an n-dimensional vector, and h_{t-1,S}=(h_{t-1,S} (1), x_{t-1,S}(2), . . . , h_{t-1,S}(n))^{T}, ^{T} represents transposition.

### <Gate Calculation Unit 130>

The gate calculation unit 130 uses the data x_{t,n,S} at each time point t and the state vector h_{t-1,S} as inputs, obtains the gate z_{t,S} by the following expression using the parameters U_{z}∈R^{n×n}, W_{z}∈R^{n×d}, and B_{z}∈Rⁿ and the activation function γ that doubly exponentially converges to 0 or 1 with respect to the input (S130), and outputs the gate z_{t,S}.

$$[ Math . 12 ]$$

$$z = σ ( α ( {U}_{z} h + {W}_{z} x + {b}_{z} ) ) ∈ {( 0 , 1 )}^{n} \qquad ( 12 )$$

In order to simplify the description, in the expression, the data x_{t,n,S} is denoted as data x, the state vector h_{t-1,S} is denoted as h, and the data z_{t,S} is denoted as z. The activation function γ is a composite function β(α( )) of the activation function β and the auxiliary function α.

For example, the gate calculation unit 130 includes a linear transformation calculation unit 131, an auxiliary function calculation unit 133, and an activation function calculation unit 135.

The linear transformation calculation unit 131 uses the data x_{t,n,S} at each time point t and the state vector h_{t-1,S} as inputs, calculates linear transformation of the following expression using the parameters U_{z}∈R^{n×n}, W_{z}∈R^{n×d}, B_{z}∈Rⁿ (S131), and outputs the transformation result Jₜ.

$$[ Math . 13 ]$$

$$J = {U}_{z} h + {W}_{z} x + {b}_{z} \qquad ( 13 )$$

In order to simplify the description, in the expression, the data x_{t,n,S} is denoted as data x, the state vector h_{t-1,S} is denoted as h, and the data J_{t,S} is denoted as J.

The auxiliary function calculation unit 133 uses the transformation result J_{t,S} as an input, calculates an auxiliary function α(J_{t,S}) (S133), and outputs a calculation result K_{t,S}=α(J_{t,S}). As the auxiliary function α( ), for example, a hyperbolic sine function sin h( ) or the like can be used. The auxiliary function α is a function that satisfies the following property (i).
(i) α(x)>>x for large positive or negative x

Furthermore, the auxiliary function α may satisfy the following properties (ii) and (iii) so that the behavior does not greatly deviate from the conventional activation function.
(ii) α′(0)=0 (differential coefficient at origin is 0)
(iii) α(−x)=−α(x) (α is an odd function)

The activation function calculation unit 135 uses the value K_{t,S} of the auxiliary function as an input, calculates the activation function β(K_{t,S}) (S135), and outputs the calculation result as the gate z_{t,S}. Therefore, z_{t,S}=β(K_{t,S}). As the activation function β( ), for example, a sigmoid function σ( ) can be used.

### <State Update Calculation Unit 140>

The state update calculation unit 140 uses the update term ⁻h_{t,S} and the gate z_{t,S} as an input, calculates a convex combination of the update term ⁻h_{t,S} and the state vector h_{t-1,S} by the following expression using the gate z_{t,S}, obtains a state vector h_{t,S} at the time point t (S140), and outputs the state vector h_{t,S}.

$$[ Math . 14 ]$$

$${h}_{t , s} = ( 1 - {z}_{t , S} ) ⊙ {h}_{t - 1 , S} + {z}_{t , S} ⊙ {\overline{h}}_{t , S} \qquad ( 14 )$$

In a component in which the gate z_{t,S} takes a value close to 1, the value of the state vector h_{t-1,S} is rewritten by the update term ⁻h_{t,S}. On the other hand, in a component in which the gate z_{t,S} takes a value close to 0, the value of the state vector h_{t-1,S} hardly changes.

The above processes S120 to S140 are repeated for T_n pieces of data x_{1,n,S}, . . . , x_{T_n,n,S} (S141).

The state update calculation unit 140 outputs the state vectors h_{1,S}, . . . , h_{T_n-1,S} corresponding to the pieces of data x_{1,n,S}, . . . , x_{T_n-1,n,S}, respectively, to the update term calculation unit 120 and the gate calculation unit 130, and outputs the state vector h_{T_n,S} corresponding to the data x_{T_n,n,S} to the output calculation unit 150.

### <Output Calculation Unit 150>

The output calculation unit 150 receives the state vector h_{T_n,S} as input, calculates an estimated value of a desired output using the state vector h_{T_n,S} (S150), and outputs a calculation result Y′_{n,S}.

### <Parameter Update Unit 160>

The parameter update unit 160 uses the desired output values Y_{n,S} and the calculation result Y′_{n,S} as inputs, and calculates, for the loss function L of these values, the gradient of the loss function L with respect to each parameter U_{z}, Uᵣ, Uₕ∈R^{n×n}, W_{z}, Wᵣ, Wₕ∈R^{n×d}, B_{z}, Bᵣ, Bₕ∈Rⁿ. The parameter update unit 160 updates the parameter by an optimization method such as a gradient method using the calculated gradient value (S160), and outputs the updated parameter P′=(U_{z}, Uᵣ, Uₕ, W_{z}, Wᵣ, Wₕ, B_{z}, Bᵣ, Bₕ) to each unit.

The parameter update unit 160 controls each unit to repeat the above-described processes S120 to S160 until a predetermined condition is satisfied, and when the predetermined condition is satisfied (YES in S161), the parameter at that time is output as the parameter P of the learned gated RNN. The predetermined condition is a condition for determining whether or not learning of the gated RNN has converged. For example, the condition is that the number of repetitions exceeds a predetermined number of times or that a difference between the parameters P before and after the update is equal to or less than a predetermined value.

Learning may be performed using all data included in the learning data set (X_{S}, Y_{S}), or learning may be performed using a part thereof. The same learning data may be used only once or repeatedly.

### <Estimation Device 200>

Next, the estimation device 200 will be described with reference to FIGS. 6 and 7. The estimation device 200 is different from the learning device 100 in that the parameter update unit 160 is not included and that the estimation target sequence data X is input instead of the learning data set (X_{S}, Y_{S}) and the estimation result Y is output. Hereinafter, a process of each unit will be described. However, a processing method of each unit is similar to that of each unit of the learning device 100.

### <Preprocessing Unit 210>

The preprocessing unit 210 receives sequence data X to be estimated as an input, converts the data into a form such as a vector that can be processed by the gated RNN (S210), and outputs the converted sequence data X′. Transformation processing similar to that of the preprocessing unit 110 may be performed. X′=(x₁, x₂, . . . , x_{T}), t=1, 2, . . . , T, T is the total number of data included in the sequence data X′, and xₜ is t-th data included in the sequence data X′. The output data xₜ at each time point are sequentially input to the gated RNN.

### <Update Term Calculation Unit 220>

The update term calculation unit 220 uses the data xₜ and the state vector hₜ₋₁ as inputs, calculates the update term ⁻hₜ by the following expression using the parameters Uᵣ, Uₕ∈R^{n×n}, Wᵣ, Wₕ∈R^{n×d}, Bᵣ, Bₕ∈Rⁿ included in the learned parameter P (S220), and outputs the update term ⁻hₜ.

$$[ Math . 15 ]$$

$$\overline{h} = tan h ( {U}_{h} ( h ⊙ σ ( {U}_{r} h + {W}_{r} x + {b}_{r} ) ) + {W}_{h} x + {b}_{h} ) \qquad ( 21 )$$

In order to simplify the description, in the expression, the data xₜ is denoted as data x, the state vector hₜ₋₁ is denoted as h, and ⁻hₜ is denoted as ⁻h. The data xₜ is a d-dimensional vector, xₜ=(xₜ(1), xₜ(2), . . . , xₜ(d))^{T}, the state vector hₜ₋₁ is an n-dimensional vector, and hₜ₋₁=(hₜ₋₁(1), xₜ₋₁(2), . . . , hₜ₋₁(n))^{T} is satisfied.

### <Gate Calculation Unit 230>

The gate calculation unit 230 receives the data xₜ and the state vector hₜ₋₁ as inputs, obtains the gate zₜ by the following expression (S230), and outputs the gate zₜ.

$$[ Math . 16 ]$$

$$z = σ ( α ( {U}_{z} h + {W}_{z} x + {b}_{z} ) ) ∈ {( 0 , 1 )}^{n} \qquad ( 22 )$$

In order to simplify the description, in the expression, the data xₜ is denoted as data x, the state vector hₜ₋₁ is denoted as h, and the data zₜ is denoted as z.

For example, the gate calculation unit 230 includes a linear transformation calculation unit 231, an auxiliary function calculation unit 233, and an activation function calculation unit 235.

The linear transformation calculation unit 231 uses the data xₜ and the state vector hₜ₋₁ as inputs, calculates linear transformation of the following expression using the parameters U_{z}∈R^{n×n}, W_{z}∈R^{n×d}, B_{z}∈Rⁿ included in the learned parameter P (S231), and outputs the transformation result Jₜ.

$$[ Math . 17 ]$$

$$J = {U}_{z} h + {W}_{z} x + {b}_{z} \qquad ( 23 )$$

In order to simplify the description, in the expression, the data xₜ is denoted as data x, the state vector hₜ₋₁ is denoted as h, and the data Jₜ is denoted as J.

The auxiliary function calculation unit 233 uses the transformation result Jₜ as an input, calculates an auxiliary function α(Jₜ) (S233), and outputs a calculation result Kₜ=α(Jₜ).

The activation function calculation unit 235 uses the value Kₜ of the auxiliary function as an input, calculates the activation function β(Kₜ) (S235), and outputs the calculation result as the gate zₜ. Therefore, zₜ=β(Kₜ) is established.

### <State Update Calculation Unit 240>

The state update calculation unit 240 uses the update term ⁻hₜ and the gate zₜ as inputs, calculates a convex combination of the update term ⁻hₜ and the state vector hₜ₋₁ by the following expression using the gate zₜ, obtains a state vector hₜ at the time point t (S240), and outputs the state vector hₜ.

$$[ Math . 18 ]$$

$${h}_{t} = ( 1 - {z}_{t} ) ⊙ {h}_{t - 1} + {z}_{t} ⊙ {\overline{h}}_{t} \qquad ( 24 )$$

The above processes S220 to S240 are repeated for T pieces of data x₁, . . . , x_{T} (S241).

The state update calculation unit 240 outputs the state vectors h₁, . . . , h_{T-1} corresponding to the pieces of data x₁, . . . , x_{T-1}, respectively, to the update term calculation unit 220 and the gate calculation unit 230, and outputs the state vector h_{T} corresponding to the data x_{T} to the output calculation unit 250.

### <Output Calculation Unit 250>

The output calculation unit 250 receives the state vector h_{T} as an input, calculates an estimated value of a desired output using the state vector h_{T} (S250), and outputs a calculation result Y.

### Effects

With the above configuration, it is possible to accurately perform inference by reflecting the correlation between pieces of input data at distant times in the estimation result of the estimation device. At that time, it is not necessary to increase the memory amount and time required for the calculation processing as in the conventional technology.

### <Modification>

Although the update gate z in the GRU has been described as an example in the present embodiment, since the present embodiment applies the auxiliary function as a preceding stage of application of the activation function σ(x), the present embodiment can be applied to any gated RNN using the sigmoid function.

### <Experiment Results>

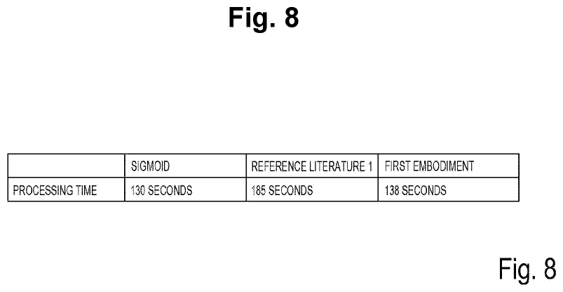

For reference, FIG. 8 illustrates the learning time actually measured in the gated RNN using each of the gate using only the sigmoid function without using the auxiliary function, the gate proposed in Reference Literature 1, and the gate in the present invention. In the method according to Reference Literature 1, the calculation time is greatly increased, whereas the increase in the calculation time due to the addition of the calculation of the auxiliary function of the gate in the present embodiment is minute and more desirable.

### <Other Modifications>

The present invention is not limited to the above-described embodiments and modifications. For example, various kinds of processing described above may be executed not only in time series in accordance with the description but also in parallel or individually in accordance with processing abilities of the devices that execute the processing or as necessary. Modifications can be made as appropriate within the scope without departing from the concept of the present invention.

### <Program and Recording Medium>

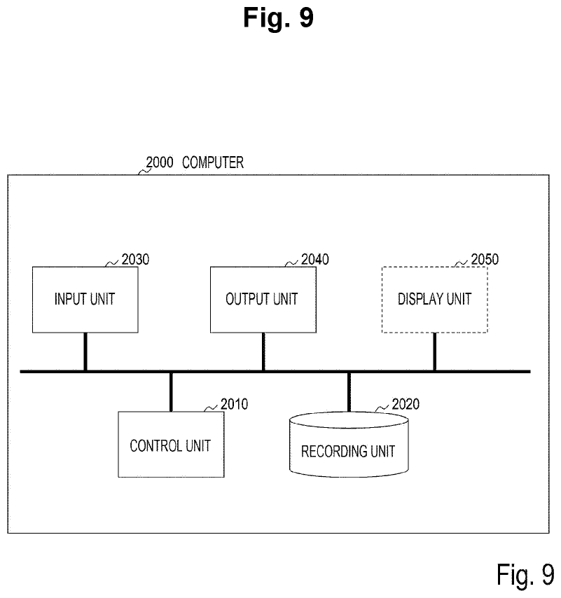

The various kinds of processing described above can be performed by causing a recording unit 2020 of a computer 2000 illustrated in FIG. 9 to read a program for executing each step of the method described above and causing a control unit 2010, an input unit 2030, an output unit 2040, a display unit 2050, and the like to operate.

The program describing the processing content may be recorded on a computer-readable recording medium. The computer-readable recording medium may be, for example, any recording medium such as a magnetic recording device, an optical disc, a magneto-optical recording medium, or a semiconductor memory.

Distribution of the program is performed by, for example, selling, transferring, or renting a portable recording medium such as a DVD or a CD-ROM on which the program is recorded. Furthermore, a configuration in which the program is distributed by storing the program in a storage device of a server computer and transferring the program from the server computer to other computers via a network may also be employed.

For example, a computer that executes such a program first temporarily stores a program recorded on a portable recording medium or a program transferred from the server computer in a storage device of the own computer. In addition, when executing processing, the computer reads the program stored in the recording medium of the own computer and executes the processing according to the read program. In addition, as another mode of the program, the computer may read the program directly from the portable recording medium and execute processing according to the program, or alternatively, the computer may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Further, the program according to the present embodiment is assumed to include information used for processing by an electronic computer and an equivalent to the program (data or the like that is not a direct command to the computer but has a feature that defines processing of the computer).

Although the present devices are each configured by executing a predetermined program on a computer in the present embodiments, at least part of the processing content may be implemented by hardware.

### REFERENCE SIGNS LIST

100 Learning device
110 Preprocessing unit
120 Update term calculation unit
130 Gate calculation unit
131 Linear transformation calculation unit
133 Auxiliary function calculation unit
135 Activation function calculation unit
140 State update calculation unit
150 Output calculation unit
160 Parameter update unit
200 Estimation device
210 Preprocessing unit
220 Update term calculation unit
230 Gate calculation unit
231 Linear transformation calculation unit
233 Auxiliary function calculation unit
235 Activation function calculation unit
240 State update calculation unit
250 Output calculation unit
2000 Computer
2010 Control unit
2020 Recording unit
2030 Input unit
2040 Output unit
2050 Display unit

1. A learning device that learns a gated recurrent neural network, the learning device comprising:
a gate calculation unit that obtains a gate z_{t,S} at a time point t using data x_{t,n,S} at the time point t included in sequence data for learning and a state vector h_{t-1,S} at the time point t,
wherein the gate calculation unit uses an activation function 7 that converges to 0 or 1 in a double exponential manner with respect to an input when obtaining the gate z_{t,S}.

2. The learning device according to claim 1,
wherein the data x_{t,n,S} is a d-dimensional vector and the state vector h_{t-1,S} is an n-dimensional vector,
the gate calculation unit includes:
a linear transformation calculation unit that calculates linear transformation using parameters U_{z}∈R^{n×n}, W_{z}∈R^{n×d}, B_{z}∈Rⁿ;
an auxiliary function calculation unit that gives a result J of the linear transformation to an auxiliary function α and performs calculation; and
an activation function calculation unit that gives a calculation result of the auxiliary function calculation unit to an activation function β and performs calculation, and
the auxiliary function α is a hyperbolic sine function, the activation function β is a sigmoid function, and the activation function γ is a composite function β(α(J)) of the auxiliary function α and the activation function β.

3. An estimation device that receives a gated recurrent neural network learned by the learning device, the estimation device comprising:
a gate calculation unit that obtains a gate zₜ at a time point t using data xₜ at the time point t included in sequence data to be estimated and a state vector hₜ₋₁ at the time point t,
wherein the gate calculation unit uses an activation function that converges to 0 or 1 in a double exponential manner with respect to an input when obtaining the gate zₜ.

4. A learning method of learning a gated recurrent neural network, the learning method comprising:
obtaining a gate z_{t,S} at a time point t using data x_{t,n,S} at the time point t included in sequence data for learning and a state vector h_{t-1,S} at the time point t,
wherein, an activation function γ that converges to 0 or 1 in a double exponential manner with respect to an input is used when obtaining the gate z_{t,S}.

5. The learning method of learning the gated recurrent neural network according to claim 4, further comprising:
an estimation method, wherein the estimation method obtains a gate zₜ at a time point t using data xₜ at the time point t included in sequence data to be estimated and a state vector hₜ₋₁ at the time point t,
wherein, an activation function that converges to 0 or 1 in a double exponential manner with respect to an input is used when obtaining the gate zₜ.

6. A program for causing a computer to function as the learning device according to claim 1.

7. A program for causing a computer to function as the estimation device according to claim 4.
